(19) United States
(12) Patent Application Publication
(10) Pub. No.: US 2012/0120114 A1
(43) Pub. Date: May 17, 2012

(54) GRAPHICAL USER INTERFACE IN MULTIMEDIA APPARATUS AND GRAPHIC OBJECT BROWSING METHOD AND SYSTEM THEREOF

(75) Inventors: Tun Hao YOU, New Taipei City (TW); Yi Jen Yeh, Toufen Township (TW); Tsung Pin Chiang, Kaohsiung City (TW); Chen Hwa Song, Taipei City (TW)

(73) Assignee: INDUSTRIAL TECHNOLOGY RESEARCH INSTITUTE, Chutung (TW)

(21) Appl. No.: 13/238,423

(22) Filed: Sep. 21, 2011

(30) Foreign Application Priority Data
Nov. 15, 2010 (TW) 099139153

(51) Int. Cl. G09G 5/00

(52) U.S. Cl. 345/676

(57) ABSTRACT

A graphic object browsing method includes the steps of: providing a Graphical User Interface (GUI) on a display, in which the GUI includes a main displaying area for displaying a plurality of graphic objects; receiving a tilt signal, in which the tilt signal includes a tilt direction and a tilt degree; displaying the plurality of graphic objects sliding on the main displaying area according to the tilt direction of the tilt signal; and controlling the sliding speed of the plurality of graphic objects according to the tilt degree of the tilt signal.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

This disclosure relates to a Graphical User Interface (GUI) on a display in a multimedia apparatus and a graphic object browsing method and system thereof.

2. Description of Related Art Including Information Disclosed Under 37 CFR 1.97 and 37 CFR 1.98.

In recent years, with the flourishing development of embedded systems (such as the Android system launched by Google), smartphones are booming on the market. Home appliance products are also successively introduced with embedded systems to become so-called intelligent home appliances or information appliances, adding to the ever-increasing range of everyday applications connecting the household to the digital network.

In view of the rather fast development of embedded system platforms in the mobile phone market, several home appliance manufacturers are considering that an existing embedded system platform may be directly implanted into home appliance products based on the development of the mobile phone market. However, due to differences between home appliances and mobile phones, such as screen sizes, functions or number of operators, key components such as human-computer interfaces need to be very different for intelligent home appliances compared to those of mobile phones. For example, a human-computer interface on a mobile phone is mainly used for individuals, and therefore mostly a small screen is adopted. However, the user demand for a television is the opposite to that of a mobile phone. Accordingly, the human-computer interface on an intelligent home appliance must consider different user requirements including use experience of multiple users, screen size, and convenience of remote operation.

Remote control apparatus are essential in this wave of intelligent home appliances. Most home appliance remote controls with conventional buttons still have room for improvement. Current remote controls designed for intelligent home appliances include a motion sensor based on an accelerometer. Some current approaches map a value generated by the motion sensor, such as accelerometer, gyroscope, directly to an X-Y coordinate system on a display, so the value is used as a cursor. Few multimedia GUIs are designed according to characteristics of the motion sensor, which is more intuitive.

Currently, during watching TV, a user has to continuously press a button to switch a channel or an option. With the continuous increase of the number of channels, browsing channel programs to find a desirable program becomes increasingly tedious. On the other hand, an interface that displays only one channel picture at a time is also inconvenient to the user. Several suppliers now manufacture remote controls with a built-in accelerometer, while other systems support the use of smartphones for remote control; however, none of the presently-available GUI designs offer truly user-friendly operation.

Accordingly, a GUI on a display in a multimedia apparatus and a graphic object browsing method and system thereof are needed in the industry, so as to provide a user interface for a user to more intuitively browse and select a graphic object.

### BRIEF SUMMARY OF THE INVENTION

An embodiment of this disclosure provides a graphic object browsing method for a display of a multimedia apparatus. The graphic object browsing method includes the steps of: providing a GUI on a display, in which the GUI includes a main displaying area for displaying a plurality of graphic objects; receiving a tilt signal, in which the tilt signal includes a tilt direction and a tilt degree; displaying the plurality of graphic objects sliding on the main displaying area according to the tilt direction of the tilt signal; and controlling the sliding speed of the plurality of graphic objects according to the tilt degree of the tilt signal.

Another embodiment of this disclosure provides a graphic object browsing system for a display of a multimedia apparatus. The system includes a display, a remote control apparatus, and a multimedia control unit. The display is configured to display graphic objects representing a plurality of multimedia files. The remote control apparatus is configured to generate a tilt signal according to an input signal, in which the tilt signal includes a tilt direction and a tilt degree. The multimedia control unit is configured to control the graphic objects representing the multimedia files displayed by the display according to the tilt signal. The display shows the graphic objects representing the plurality of multimedia files sliding in a direction corresponding to the tilt direction at a speed corresponding to the tilt degree.

Still another embodiment of this disclosure provides a GUI for graphic object browsing for a display of a multimedia apparatus. The GUI includes a main displaying area and a tilt movement displaying area. The main displaying area is configured to display a plurality of graphic objects. The tilt movement displaying area is configured to display a tilt signal, in which the tilt signal includes a tilt direction and a tilt degree. The plurality of graphic objects displayed in the main displaying area slide according to the tilt direction displayed in the tilt movement displaying area, and a sliding speed of the graphic objects corresponds to the tilt degree displayed in the tilt movement displaying area.

### BRIEF DESCRIPTION OF THE SEVERAL VIEWS OF THE DRAWINGS

The accompanying drawings, which are incorporated in and constitute a part of this specification, illustrate embodiments of the disclosure and, together with the description, serve to explain the principles of the invention.

FIG. 1 illustrates a graphic object browsing system for a display of a multimedia apparatus according to an embodiment of this disclosure;

FIG. 2 is a schematic view of a GUI browsing for a display of a multimedia apparatus according to an embodiment of this disclosure;

FIG. 3 is a flow chart of a graphic object browsing method for a display of a multimedia apparatus according to an embodiment of this disclosure;

FIG. 4 is a partial flow chart of a graphic object browsing method for a display of a multimedia apparatus according to an embodiment of this disclosure;

FIG. 5 is another schematic view of a GUI browsing for a display of a multimedia apparatus according to an embodiment of this disclosure;

FIG. 6 is yet another schematic view of a GUI browsing for a display of a multimedia apparatus according to an embodiment of this disclosure;

FIG. 7 is yet another schematic view of a GUI browsing for a display of a multimedia apparatus according to an embodiment of this disclosure;

FIG. 8 is a schematic view of a GUI browsing for a display of a multimedia apparatus according to still another embodiment of this disclosure; and

FIG. 9 is a schematic view of a GUI browsing for a display of a multimedia apparatus according to another embodiment of this disclosure.

### DETAILED DESCRIPTION OF THE INVENTION

This disclosure proposes a GUI browsing and selection, and a graphic object browsing method and system thereof that is more intuitive than those in the prior art. In this disclosure, life experiences of an ordinary user, that is, a concept that an object slides off a flat surfaces that is tilted, are used as an operation reference for graphic object browsing. The user does not need to learn how to operate, but instead can observe graphic object arrangement displayed by a display, and when the tilt begins, a graphic object on a picture begins to slide. A larger tilt angle means a higher sliding speed, which conforms to the intuition and experience in daily life. Compared with a conventional displaying interface, the GUI and the graphic object browsing method and system thereof according to this disclosure are more intuitive, and are also more convenient for fast browsing and easy operation by a user.

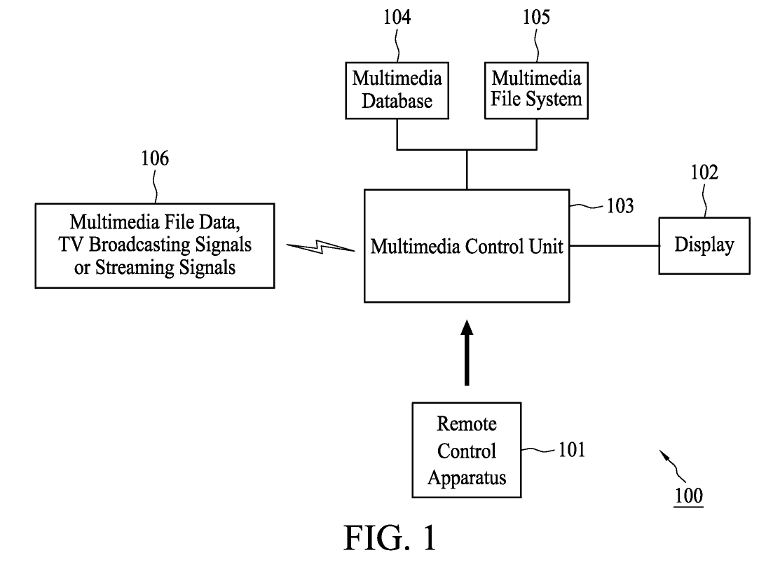

FIG. 1 illustrates a graphic object browsing system for a display of a multimedia apparatus according to an embodiment of this disclosure. As shown in FIG. 1, the multimedia graphic object browsing system 100 includes a remote control apparatus 101, a display 102, a multimedia control unit 103, a multimedia database 104 and a multimedia file system 105. The remote control apparatus 101 may generate a tilt signal according to an input of a user. The display 102 is configured to display a graphic object representing a multimedia file, in which the multimedia file may be from the multimedia database 104 or the multimedia file system 105, or may be external multimedia files, for example, multimedia file data, TV broadcasting signals or streaming signals 106 received through wireless transmission. The multimedia control unit 103 can control the graphic object displayed by the display 102 according to the tilt signal sent by the remote control apparatus 101.

According to an embodiment of this disclosure, a sensor may be built in the remote control apparatus 101 and configured to detect a tilt angle and direction of the remote control apparatus 101 and convert the tilt angle and direction into the tilt signal. According to an embodiment of this disclosure, but this disclosure is not limited thereto, the sensor may be an accelerometer. Persons skilled in the art know that an acceleration value detected by the accelerometer may be converted into a tilt angle through the principles of trigonometric functions, so the tilt angle is used as the tilt signal. According to another embodiment of this disclosure, the remote control apparatus 101 may be a keyboard, and the tilt signal may be converted from a signal input by a user through the keys of the keyboard or keypad. According to yet another embodiment of this disclosure, the remote control apparatus 101 may be an apparatus equipped with a touch screen, and the tilt signal may be converted from a signal generated by touching the touch screen by a user. According to still another embodiment of this disclosure, the remote control apparatus 101 may be a camera, and the tilt signal may be converted from a body movement of a user captured by the camera. According to still another embodiment of this disclosure, the remote control apparatus 101 may be a microphone, and the tilt signal may be converted from a sound instruction of a user received by the microphone.

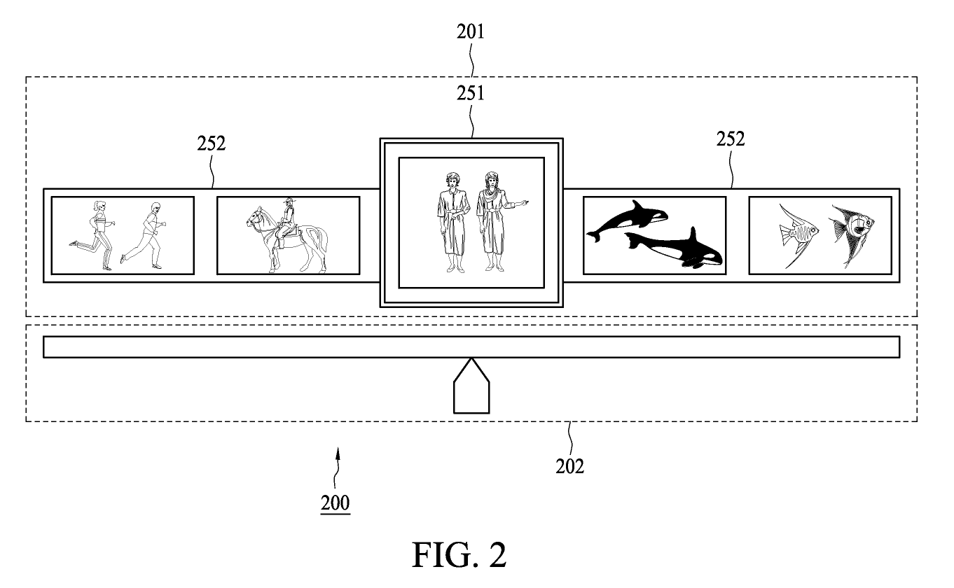

FIG. 2 is a schematic view of a GUI browsing for a display of a multimedia apparatus according to an embodiment of this disclosure. As shown in FIG. 2, the GUI 200 includes a main displaying area 201 and a tilt movement displaying area 202. The main displaying area 201 is used to display a plurality of multimedia graphic objects. The tilt movement displaying area 202 is used to display a tilt signal, in which the tilt signal includes information such as a tilt direction and a tilt degree. The main displaying area 201 includes an item selection area 251 and an item displaying area 252. The plurality of multimedia graphic objects displayed on the main displaying area 201 are displayed at the item selection area 251 and the item displaying area 252, and the plurality of multimedia graphic objects may slide from the item selection area 251 to the item displaying area 252, or slide from the item displaying area 252 to the item selection area 251. In order to highlight the multimedia graphic objects displayed at the item selection area 251, the appearances of the multimedia graphic objects displayed at the item selection area 251 are different from the appearances of the multimedia graphic objects displayed at the item displaying area 252.

According to an embodiment of this disclosure, the tilt movement displaying area 202 may display a seesaw, and a tilt direction and a tilt degree of the tilt signal may be displayed through a tilt direction and a tilt angle of the seesaw. According to another embodiment of this disclosure, the tilt movement displaying area 202 may display a level or an indicator, in which the level or the indicator may display a current tilt direction and current tilt degree.

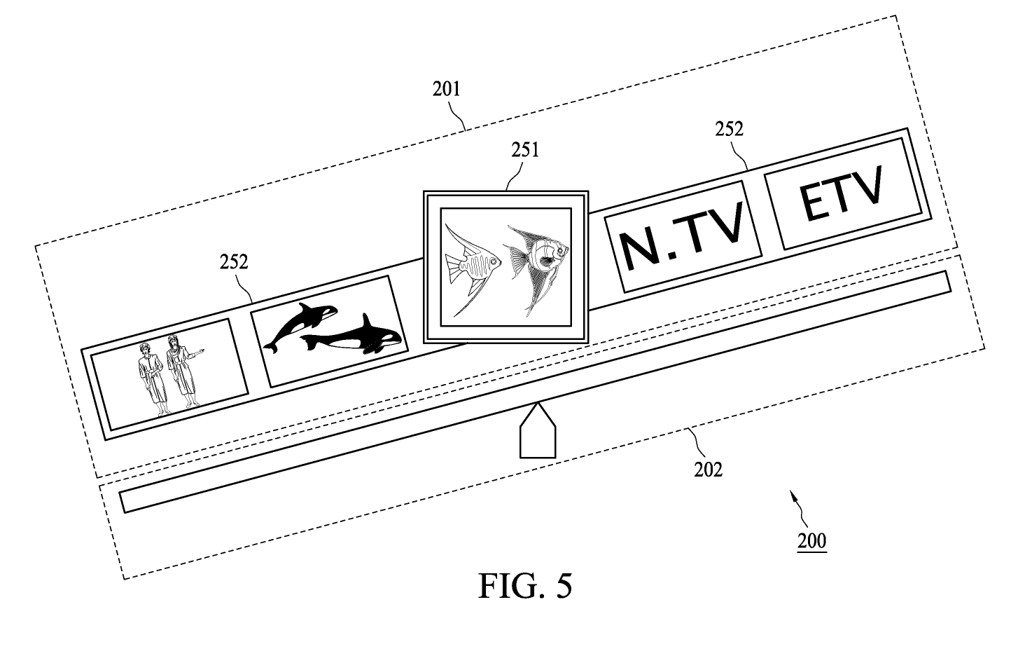

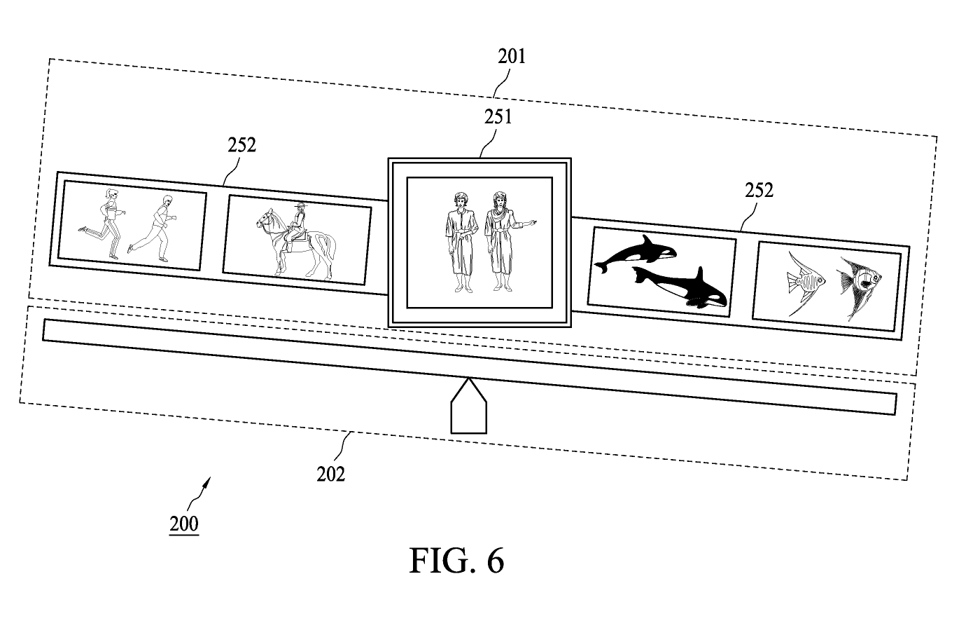

The tilt direction of the tilt signal may be to the left or to the right, as shown in FIGS. 5 and 6. When the received tilt direction is to the right, the plurality of multimedia graphic objects displayed on the main displaying area 201 may slide from upper left to lower right, and the tilt angle thereof corresponds to the tilt degree of the tilt signal. Similarly, when the received tilt direction is to the left, the plurality of multimedia graphic objects displayed on the main displaying area 201 may slide from upper right to lower left, and the tilt angle thereof corresponds to the tilt degree of the tilt signal. In this way, by observing a picture, in which an object slides off a flat surface while tilting, displayed on a screen, a user may more intuitively browse and select a multimedia graphic object.

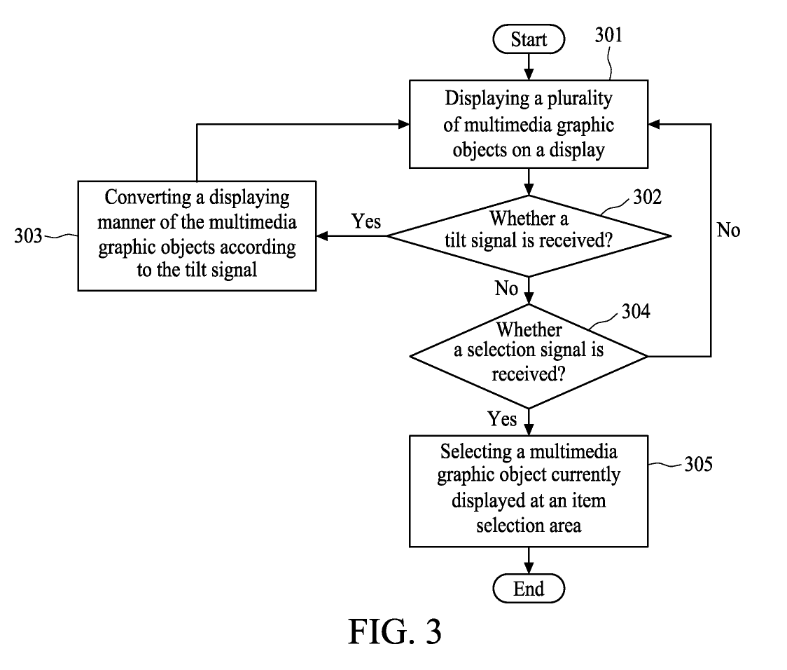

FIG. 3 is a flow chart of a graphic object browsing method for a display of a multimedia apparatus according to an embodiment of this disclosure. In Step 301, a plurality of multimedia graphic objects is displayed on a display, and Step 302 is executed. In Step 302, it is checked whether a tilt signal is received. If a tilt signal is received, Step 303 is executed; otherwise Step 304 is executed. In Step 303, a displaying manner of the multimedia graphic objects is converted according to the tilt signal, and the process returns to Step 301. In Step 304, it is checked whether a selection signal is received. If a selection signal is received, Step 305 is executed. In Step 305, a multimedia graphic object currently displayed in an item selection area is selected. It should be noted that the method in FIG. 3 is not limited to being applied only once, and if an item to be selected has a hierarchy or attachment relation, the method in FIG. 3 may be repetitively applied to select a required item.

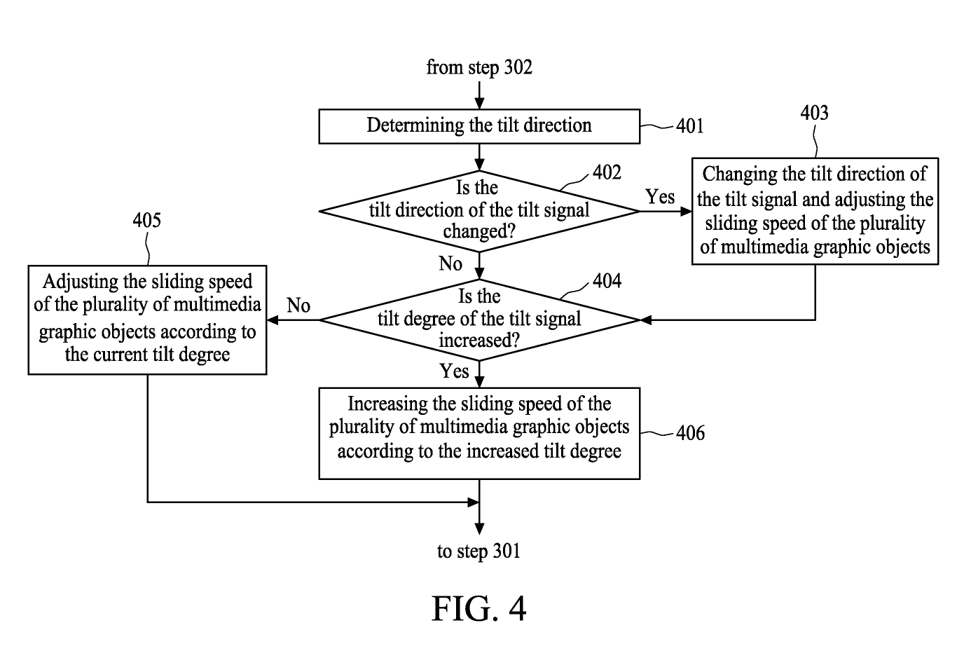

FIG. 4 shows a detailed flow chart of Step 303. In Step 401, according to the received tilt signal, the tilt direction specified in the tilt signal is determined, and Step 402 is executed. In Step 402, it is checked whether the tilt direction of the tilt signal is changed. If the tilt direction of the tilt signal is changed, Step 403 is executed; otherwise Step 404 is executed. In Step 403, the tilt direction of the tilt signal is changed and the sliding speed of the plurality of multimedia graphic objects is adjusted, which may be adjusted as lower than the sliding speed corresponding to the tilt degree of the tilt signal, and then Step 404 is executed. In Step 404, it is checked whether the tilt degree of the tilt signal is increased. If the tilt degree of the tilt signal is increased, Step 406 is executed; otherwise Step 405 is executed. In Step 405, according to the current tilt degree, the sliding speed of the plurality of multimedia graphic objects is adjusted accordingly, and then the process returns to Step 301. In Step 406, the sliding speed of the plurality of multimedia graphic objects is increased according to the increased tilt degree, and then the process returns to Step 301.

According to an embodiment of this disclosure, in Step 405, if the tilt degree of the tilt signal is unchanged, the sliding speed of the plurality of multimedia graphic objects may be increased. In this way, it may be simulated that the sliding speed of the object increases due to gravity. In other words, the tilt degree may also depend on the duration of the received tilt signal, and a greater duration of received tilt signal corresponds to more acceleration according to the principle of momentum. According to still another embodiment of this disclosure, in Step 403, since the tilt direction of the tilt signal has been changed, the plurality of multimedia graphic objects may first slide at a speed lower than the sliding speed corresponding to the tilt degree of the tilt signal, and then the sliding speed of the plurality of multimedia graphic objects is increased to correspond to the tilt degree of the tilt signal. In this way, when a user browses the plurality of multimedia graphic objects and misses a multimedia graphic object to select, the user may conveniently return to select the multimedia graphic object to select. The sliding speed of the plurality of multimedia graphic objects may also be set to a fixed speed.

In combination with the embodiments relating to a GUI on a display in a multimedia apparatus and a graphic object browsing method and system thereof according to this disclosure, an implementation example in which a user browses a multimedia graphic object is provided as follows. In this implementation example, the remote control apparatus 101 is a handheld remote control embedded with a sensor. In the initial setting, a horizontal angle of the sensor may first be calibrated. FIG. 2 illustrates an initial state of the GUI 200, in which the main displaying area 201 displays only a portion of the multimedia graphic objects. If a multimedia graphic object that a user intends to select is not displayed in the item selection area 251, the remote control apparatus 101 may be tilted, for example, tilted to the left.

After receiving the tilt signal, the multimedia control unit 103 may obtain the tilt direction and the tilt angle according to the tilt signal. Accordingly, the main displaying area 201 may begin to tilt to the left according to the tilt direction and the tilt angle, as shown in FIG. 4. Meanwhile, the tilt movement displaying area 202 also displays the corresponding tilt direction and the corresponding tilt angle according to the tilt direction and the tilt angle. For example, if the tilt movement displaying area 202 displays a seesaw, the seesaw may be rotated according to the tilt direction and the tilt angle. Furthermore, the plurality of multimedia graphic objects displayed in the main displaying area 201 slides in the tilt direction, in which a greater tilt angle corresponds to a greater sliding speed of the plurality of multimedia graphic objects. The sliding speed of the plurality of multimedia graphic objects may also be set to a fixed speed.

As the plurality of multimedia graphic objects slides, the multimedia graphic objects originally displayed in the item selection area 251 slide out of the item selection area 251, and are replaced with other multimedia graphic objects sliding into the item selection area 251 from the item displaying area 252. Meanwhile, if the tilt signal shifts to the left, a multimedia graphic object at the left edge of the main displaying area 201 slides out of the displaying range and disappears, and a multimedia graphic object originally not displayed in the main displaying area 201 is added at the right edge of the main displaying area 201 through a sliding movement.

In this implementation example, when a multimedia graphic object that a user intends to select appears, it is possible that the user cannot select the multimedia graphic object due to the excessively high sliding speed when the multimedia graphic object is displayed in the item selection area 251. At this time, the user may tilt the remote control apparatus 101 in the opposite direction. When the received tilt signal is rotated from a certain direction to another direction, the sliding speed of the plurality of multimedia graphic objects in the main displaying area 201 in an opposite direction may be slightly lower than that in an ordinary state, and then is restored to the original sliding speed, for example, the left-tilting direction in FIG. 5 is changed to the right-tilting direction in FIG. 6. In this way, the user may select the desired multimedia graphic object more correctly and precisely.

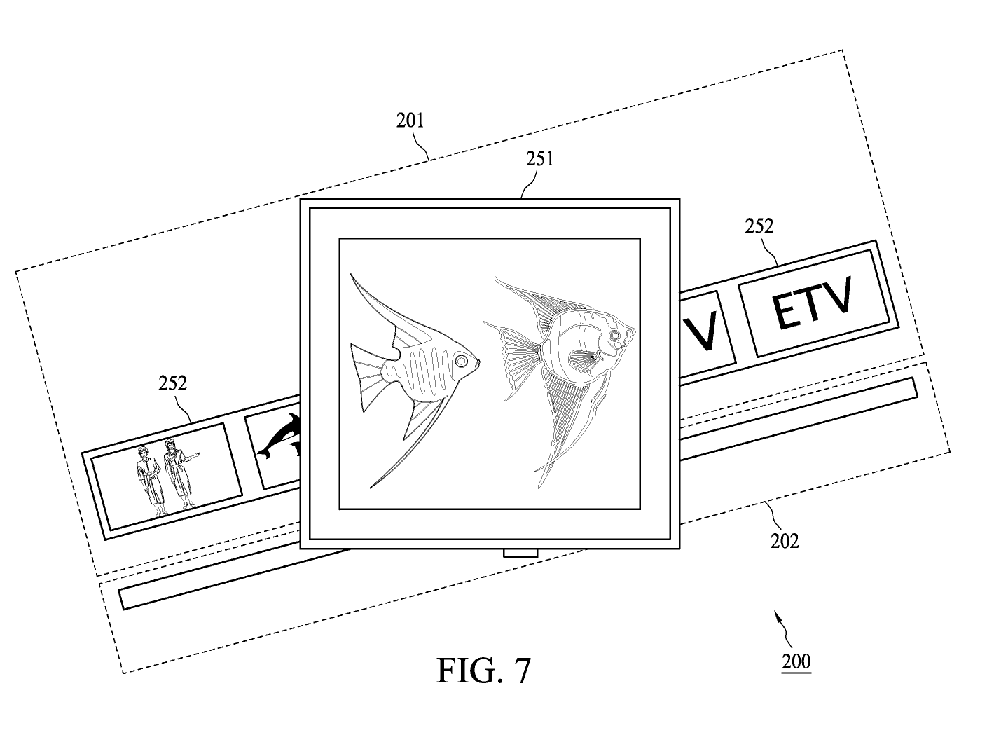

When the multimedia graphic object that the user intends to select is displayed in the item selection area 251, the user may select the multimedia graphic object by inputting a selection signal. In this implementation example, the selection signal may be converted from a detected rolling-over movement of the remote control apparatus 101. According to another embodiment of this disclosure, the selection signal may be converted from a signal input by the user by pressing keys. According to another embodiment of this disclosure, the selection signal may be converted from a body movement of the user captured by the camera. According to another embodiment of this disclosure, the selection signal may be converted from a sound instruction of a user received by a microphone. It should be noted that the aforesaid embodiments regarding the selection signal are used for illustrative purpose only and this disclosure is not limited to those embodiments. As shown in FIG. 7, when a user inputs a selection signal, the GUI 200 enlarges the selected multimedia graphic object for display to represent that the selection signal is received.

According to an embodiment of this disclosure, the main displaying area 201 may display the plurality of multimedia graphic objects in a head-to-tail manner. For example, if the plurality of multimedia graphic objects comprises graphic objects representing Channels 1 to 100, the main displaying area 201 may display five continuous channels, for example, Channels 21 to 25. When Channel 100 is displayed, Channels 97, 98, 99, 100 and 1 may be displayed in sequence in the main displaying area 201. In this way, the user may browse the multimedia graphic object in either tilt direction, so the time for sliding to the multimedia graphic object that the user intends to select may be reduced.

According to an embodiment of this disclosure, the main displaying area 201 may preset a subset of the multimedia graphic objects. For example, an item frequently browsed by the user may be preset. When the user browses the preset multimedia graphic objects, the sliding speed may become lower for ease of selection by the user. According to an embodiment of this disclosure, the preset multimedia graphic objects may be consecutively arranged, not subject to the original sequence of the multimedia graphic objects. Meanwhile, different users may respectively have a set of preset multimedia graphic objects, so each user can select a multimedia graphic object more conveniently.

The tilt direction of the tilt signal according to this disclosure is not limited to the tilt to the left or to the right, and may also correspond to other tilt directions, as in cases where the user moves the remote control apparatus 101 up and down to achieve a purpose of generating the tilt signal. Similarly, the sliding direction of the multimedia graphic object displayed in the tilt movement displaying area 202 is not limited to the sliding from upper right to lower left and the sliding from upper left to lower right neither, and should cover any sliding direction in a three-dimensional space.

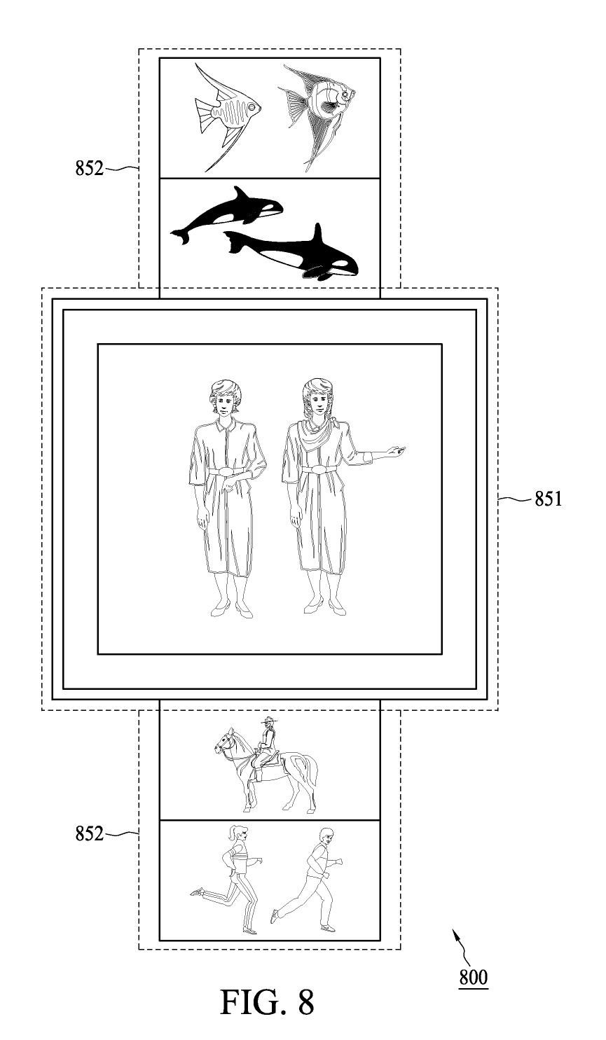

FIG. 8 is a schematic view of a GUI browsing for a display of a multimedia apparatus according to another embodiment of this disclosure. As shown in FIG. 8, the GUI 800 is used to display a plurality of multimedia graphic objects, and includes an item selection area 851 and an item displaying area 852. The plurality of multimedia graphic objects are displayed in the item selection area 851 and the item displaying area 852, and the plurality of multimedia graphic objects may slide from the item selection area 851 to the item displaying area 852, or slide from the item displaying area 852 to the item selection area 851. In order to highlight the multimedia graphic objects displayed at the item selection area 851, the appearances of the multimedia graphic objects displayed in the item selection area 851 are different from the appearances of the multimedia graphic objects displayed in the item displaying area 852. In contrast to the GUI 200 in FIG. 2, the GUI 800 displays a selection process of the plurality of multimedia graphic objects in manners of sliding from top to bottom and sliding from bottom to top.

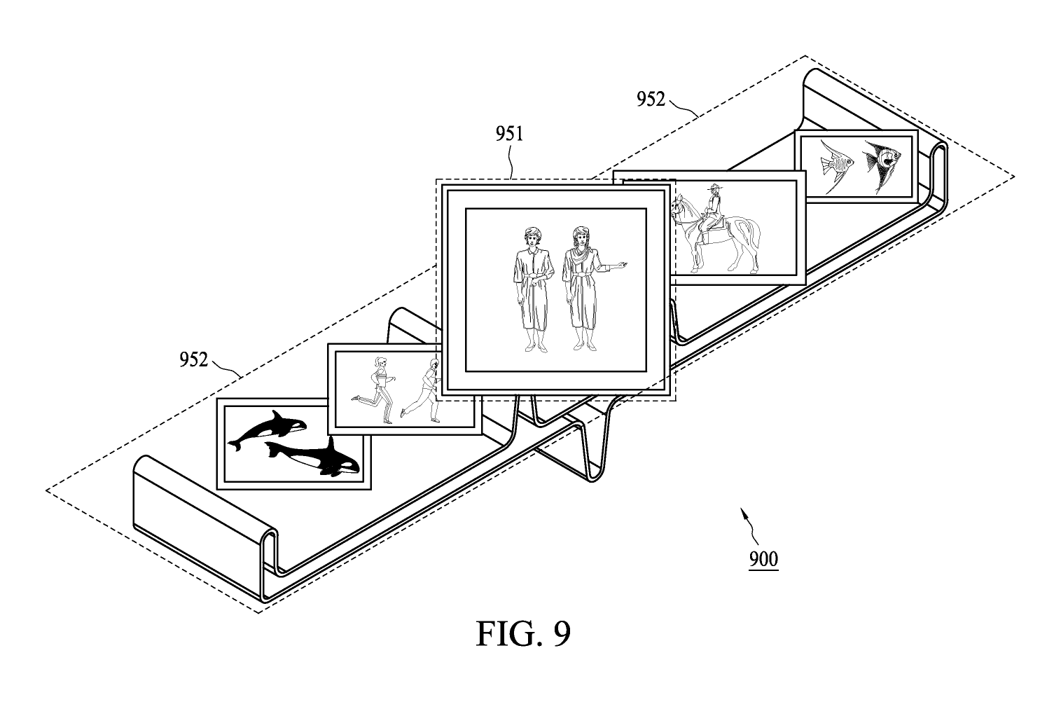

FIG. 9 is a schematic view of a GUI browsing for a display of a multimedia apparatus according to another embodiment of this disclosure. As shown in FIG. 9, the GUI 900 is used to display a plurality of multimedia graphic objects, and includes an item selection area 951 and an item displaying area 952. The plurality of multimedia graphic objects are displayed in the item selection area 951 and the item displaying area 952, and the plurality of multimedia graphic objects may slide from the item selection area 951 to the item displaying area 952, or slide from the item displaying area 952 to the item selection area 951. In order to highlight the multimedia graphic objects displayed in the item selection area 951, the appearances of the multimedia graphic objects displayed in the item selection area 951 are different from the appearances of the multimedia graphic objects displayed in the item displaying area 952. In contrast to the GUI 200 in FIG. 2, the GUI 900 displays a selection process of the plurality of multimedia graphic objects in manners of sliding from far to near and sliding from near to far. Moreover, the GUI 900 also displays a seesaw, which may present different sliding directions in coordination with the plurality of multimedia graphic objects.

In view of the foregoing description, this disclosure uses life experiences of an ordinary user, such as the concept that an object slides off a flat surface when tilting, as an operation reference for graphic object browsing. Accordingly, the operation of the graphic object browsing system according to the embodiments of this disclosure can be achieved by watching graphic object arrangement displayed by a display, and when the tilt begins, graphic objects on a picture begin to slide off. A greater tilt angle corresponds to a greater sliding speed, which conforms to the common sense of daily life. Compared with a conventional displaying interface, the GUI and the graphic object browsing method and system thereof according to this disclosure are more intuitive, and are also more convenient for fast browsing and easy operation of a user.

The above-described exemplary embodiments are intended to be illustrative only. Those skilled in the art may devise numerous alternative embodiments without departing from the scope of the following claims.

We claim:

1. A graphic object browsing method used in a multimedia apparatus, comprising the steps of:
providing a Graphical User Interface (GUI) on a display, wherein the GUI comprises a main displaying area for displaying a plurality of graphic objects;
receiving a tilt signal, wherein the tilt signal comprises a tilt direction and a tilt degree;
displaying the plurality of graphic objects sliding on the main displaying area according to the tilt direction of the tilt signal; and
controlling the sliding speed of the plurality of graphic objects according to the tilt degree of the tilt signal.

2. The graphic object browsing method of claim 1, wherein the GUI further comprises a tilt movement displaying area to display the current tilt signal.

3. The graphic object browsing method of claim 2, wherein the displaying of the plurality of graphic objects sliding is from upper right to lower left or from upper left to lower right.

4. The graphic object browsing method of claim 3, further comprising the steps of:
displaying a seesaw in the tilt movement displaying area;
rotating the seesaw to tilt to the left if the tilt direction of the tilt signal is from upper right to lower left;
rotating the seesaw to tilt to the right if the tilt direction of the tilt signal is from upper left to lower right; and
controlling a tilt angle of the seesaw according to the tilt degree of the tilt signal.

5. The graphic object browsing method of claim 1, wherein the displaying of the plurality of graphic objects sliding is from far to near or from near to far.

6. The graphic object browsing method of claim 1, wherein the displaying of the plurality of graphic objects sliding is from top to bottom or from bottom to top.

7. The graphic object browsing method of claim 2, wherein the tilt movement displaying area is configured to display a level or an indicator, and the level or the indicator is configured to display a current tilt direction and tilt degree.

8. The graphic object browsing method of claim 1, wherein the main displaying area comprises an item selection area and an item displaying area such that the plurality of graphic objects can slide from the item selection area to the item displaying area, or slide from the item displaying area to the item selection area, and the appearances of the graphic objects displayed in the item selection area are different from the appearances of the graphic objects displayed in the item displaying area.

9. The graphic object browsing method of claim 1, further comprising the step of:
selecting a graphic object currently displayed in the item selection area if a selection signal is received.

10. The graphic object browsing method of claim 8, wherein the selection signal is converted from a rolling-over movement of a remote control apparatus detected by a sensor built in the remote control apparatus.

11. The graphic object browsing method of claim 8, wherein the selection signal is converted from an input signal received by pressing keys.

12. The graphic object browsing method of claim 8, wherein the selection signal is converted from a body movement of a user captured by a camera.

13. The graphic object browsing method of claim 8, wherein the selection signal is converted from a sound instruction of a user received by a microphone.

14. The graphic object browsing method of claim 1, further comprising the steps of:
if the tilt direction of the received tilt signal is different from the tilt direction of a previous received tilt signal, displaying the plurality of graphic objects sliding in the sliding direction of the received tilt signal on the main displaying area at a sliding speed lower than the sliding speed corresponding to the tilt degree of the received tilt signal;
restoring the sliding speed of the plurality of graphic objects to correspond to the tilt degree of the received tilt signal.

15. The graphic object browsing method of claim 1, wherein a larger tilt degree of the tilt signal corresponds to a higher sliding speed of the plurality of graphic objects.

16. The graphic object browsing method of claim 1, wherein the step of controlling the sliding speed of the plurality of graphic objects according to the tilt degree of the tilt signal comprises the sub-step of:
accelerating the sliding speed of the plurality of graphic objects if the tilt degree of the received tilt signal is equal to the tilt degree of a previous received tilt signal.

17. The graphic object browsing method of claim 1, further comprising the step of:
detecting, by a sensor built in a remote control apparatus, a tilt angle and a tilt direction of the remote control apparatus, and converting the tilt angle and the tilt direction into the tilt signal.

18. The graphic object browsing method of claim 1, wherein the tilt signal is converted from an input signal received by pressing keys.

19. The graphic object browsing method of claim 1, wherein the tilt signal is converted from a touch signal received by a touch screen.

20. The graphic object browsing method of claim 1, wherein the tilt signal is converted from a body movement of a user captured by a camera.

21. The graphic object browsing method of claim 1, wherein the tilt signal is converted from a sound instruction of a user received by a microphone.

22. A graphic object browsing system in a multimedia apparatus, comprising:
a display, configured to display graphic objects representing a plurality of multimedia files;
a remote control apparatus, configured to generate a tilt signal according to an input signal, wherein the tilt signal comprises a tilt direction and a tilt degree; and
a multimedia control unit, configured to control the graphic objects representing the multimedia files displayed by the display according to the tilt signal;
wherein the display is configured to display the graphic objects representing the plurality of multimedia files sliding in a direction corresponding to the tilt direction at a speed corresponding to the tilt degree.

23. The graphic object browsing system of claim 22, wherein the graphic objects representing the plurality of multimedia files are from a multimedia database, a multimedia file system, or are external multimedia files, TV broadcasting signals or streaming signals.

24. The graphic object browsing system of claim 22, wherein a sensor is built in the remote control apparatus and configured to detect a tilt angle and direction of the remote control apparatus and convert the tilt angle and direction into the tilt signal.

25. A Graphical User Interface (GUI) in a multimedia apparatus, comprising:
a main displaying area, configured to display a plurality of graphic objects; and
a tilt movement displaying area, configured to display a tilt signal, wherein the tilt signal comprises a tilt direction and a tilt degree;
wherein the plurality of graphic objects displayed in the main displaying area slides according to the tilt direction displayed in the tilt movement displaying area, and the sliding speed thereof corresponds to the tilt degree displayed in the tilt movement displaying area.

26. The GUI of claim 25, wherein the main displaying area comprises an item selection area and an item displaying area such that the plurality of graphic objects can slide from the item selection area to the item displaying area or slide from the item displaying area to the item selection area, and the appearances of the graphic objects displayed at the item selection area are different from the appearances of the graphic objects displayed at the item displaying area.

27. The GUI of claim 25, wherein the plurality of graphic objects comprise preset graphic objects such that when the preset graphic objects are displayed in the item selection area, the sliding speed of the plurality of graphic objects is decreased.

28. The GUI of claim 25, wherein a graphic object at the rearmost end is adjacent to a graphic object at the frontmost end such that all graphic objects are browsed when the plurality of graphic objects slides in the same direction from any graphic object.

29. The GUI of claim 25, wherein the tilt movement displaying area displays a seesaw to display the tilt direction and the tilt degree of the tilt signal.

30. The GUI of claim 25, wherein the tilt movement displaying area displays a level or an indicator to display the tilt direction and the tilt degree of the tilt signal.

31. The GUI of claim 25, wherein the sliding speed of the plurality of graphic objects displayed in the main displaying area is lower than the sliding speed corresponding to the tilt degree of the tilt signal when the direction of the tilt signal is changed.
